(19) United States
(12) Patent Application Publication
(10) Pub. No.: US 2013/0088331 A1
(43) Pub. Date: Apr. 11, 2013

(54) APPARATUS AND METHOD FOR RECOGNIZING LOCATION OF OBJECT IN LOCATION RECOGNITION SYSTEM

(71) Applicants: In-Kui CHO, Daejeon (KR); Jung-lck Moon, Daejeon (KR); Seong-Min Kim, Daejeon (KR); Je-Hoon Yun, Daejeon (KR); Woo-Jin Byun, Daejeon (KR); Jae-Ick Choi, Daejeon (KR)

(72) Inventors: In-Kui CHO, Daejeon (KR); Jung-lck Moon, Daejeon (KR); Seong-Min Kim, Daejeon (KR); Je-Hoon Yun, Daejeon (KR); Woo-Jin Byun, Daejeon (KR); Jae-Ick Choi, Daejeon (KR)

(73) Assignee: Electronics and Telecommunications Reasearch Institute, Daejeon (KR)

(21) Appl. No.: 13/568,417

(22) Filed: Aug. 7, 2012

(30) Foreign Application Priority Data
Oct. 10, 2011 (KR) 10-2011-0102979

(51) Int. Cl. G08C 17/02

(52) U.S. Cl. 340/10.1

(57) ABSTRACT

Disclosed are an apparatus and a method for recognizing a location of an object using radio frequency Identification (RFID). The method for recognizing a location of an object includes: activating tags located around radio frequency identification (RFID) tags by transmitting power to the RFID tags in a magnetic resonance type; transmitting a call signal for identifying a mobile tag attached to an object; receiving a tag identifier of the mobile tag corresponding to the call signal; receiving location information from fixed tags around the mobile tag; and recognizing the location of the mobile tag using the location information.

### CROSS-REFERENCE TO RELATED APPLICATIONS

The present application claims priority of Korean Patent Application No. 10-2011-0102979, filed on Oct. 10, 2011, which is incorporated herein by reference in its entirety.

### BACKGROUND OF THE INVENTION

1. Field of the Invention

Exemplary embodiments of the present invention relate to a location recognition system, and more particularly, to an apparatus and a method for recognizing a location of an object using Radio Frequency IDentification (hereinafter, referred to as ‘RFID’).

2. Description of Related Art

Generally, a system for recognizing a location of an object is a system for searching a location of any objects. The system for recognizing a location of an object does not sufficiently use an RFID technology, in recognizing a location of an object.

The RFID technology using an RFID reader and an RFID tag is a next-generation recognition technology for supplementing disadvantages of a bar code or a magnetic card. In addition, the RFID technology can manage information on various entities such as foods, animals, plants, and the like, by IC chip and in wireless.

The RFID technology has disadvantages in that it is difficult to miniaturize an RFID tag and sufficiently supply power to a miniaturized RFID tag. Further, in order to supply power of several mW that is required for the RFID tag, the RFID reader requires effective isotropic radiation power (or, effective radiation power of an antenna) of about 4 W. However, with the current RFID technology, it is difficult to provide sufficient power to the system for recognizing a location of an object.

### SUMMARY OF THE INVENTION

An embodiment of the present invention is directed to an apparatus and a method for recognizing a location of an object in a location recognition system.

Further, an embodiment of the present invention is directed to an apparatus and a method for recognizing a location of an object by providing power required to recognize a location of an object in a location recognition system.

In addition an embodiment of the present invention is directed to an apparatus and a method for recognizing an object using a radio frequency identification (RFID) technology in a location recognition system to allow an RFID reader to sufficiently supply power to an RFID tag.

An apparatus for recognizing a location of an object in a location recognition system, including: a power generating unit configured to generate power; a signal generating unit configured to generate a call signal including an identifier of a mobile tag so as to search a location of the mobile tag attached to an object; a signal/power transmitting unit configured to output the power and the call signal; a magnetic resonance unit configured to transmit the power in a magnetic resonance type and transmit the call signal; a control unit configured to perform a control to transmit the power and the call signal to neighboring tags; a signal receiving unit configured to receive identifier information of the mobile tag and location information of the mobile tag corresponding to the call signal through the magnetic resonance unit; and a location information processing unit configured to recognize the location of the object using the location information.

A method for recognition a location of an object in a location recognition system, including: activating tags located around radio frequency identification (RFID) tags by transmitting power to the RFID tags in a magnetic resonance type; transmitting a call signal for identifying a mobile tag attached to an object; receiving a tag identifier of the mobile tag corresponding to the call signal; receiving location information from fixed tags around the mobile tag; and recognizing the location of the mobile tag using the location information.

A method for recognizing a location of an object in a location recognition system, including: sensing a reception of a mobile tag attached to an object within a space of the location recognition system; activating tags located around radio frequency identification (RFID) tags by transmitting power to the RFID tags in a magnetic resonance type; transmitting a call signal for receiving a tag identifier of the mobile tag; receiving the tag identifier of the mobile tag corresponding to the call signal; receiving location information from fixed tags around the mobile tag; recognizing a location of the mobile tag using the location information; storing location information of the mobile tag; and providing the location information by searching the location information of the requested tag identifier, when the location information of an object required for location recognition is requested.

### BRIEF DESCRIPTION OF THE DRAWINGS

FIG. 1 is a diagram illustrating a system for recognizing a location of an object in accordance with an embodiment of the present invention.

FIGS. 2A to 2H are diagrams illustrating a system for recognizing a location of an object by partitioning a space in accordance with an embodiment of the present invention.

FIG. 3 is a diagram illustrating a use of a system for recognizing a location of an object in accordance with an embodiment of the present invention.

FIG. 4 is a flow chart illustrating an operation of a radio frequency identification (RFID) reader in accordance with an embodiment of the present invention.

FIG. 5 is a flow chart illustrating an operation of an RFID reader in accordance with another embodiment of the present invention.

FIG. 6 is a flow chart illustrating an operation of mobile RFID tags in accordance with an embodiment of the present invention.

FIG. 7 is a flow chart illustrating an operation of mobile RFID tags in accordance with another embodiment of the present invention.

FIG. 8 is a flow chart illustrating an operation of fixed RFID tags in accordance with an embodiment of the present invention.

### DESCRIPTION OF SPECIFIC EMBODIMENTS

Hereinafter, embodiments of the present invention will be described in detail with reference to the accompanying drawings. It is to be noted that only parts necessary to understand operations in accordance with embodiments of the present invention will be described below and the description of other parts will be omitted so as not to unnecessarily obscure the subject matter of the present invention.

The present invention proposes a system for recognizing a location of an object using a radio frequency Identification (RFID) technology. The system for recognizing a location of an object in accordance with an embodiment of the present invention can recognize a location of an object through a RFID reader that communicates with mobile RFID tags attached to an object and RFID tags fixed at a preset location.

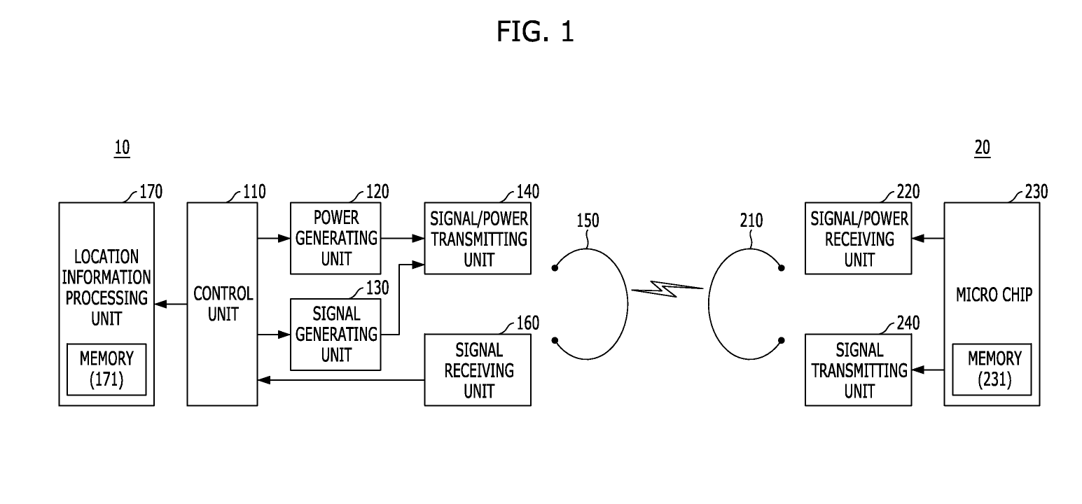

FIG. 1 is a diagram illustrating a system for recognizing a location of an object in accordance with an embodiment of the present invention.

Referring to FIG. 1, the system for recognizing a location of an object may include an RFID reader 10 and RFID tags 20. The RFID reader 10 may be an apparatus for recognizing a location of an object. Here, the RFID tags 20 may be attached to an object or may be attached to a fixed location for recognizing a location of an object.

The RFID reader 10 may include a control unit 110, a power generating unit 120, a signal generating unit 130, a signal/power transmitting unit 140, a magnetic resonance unit 150, a signal receiving unit 160, and a location information processing unit 170.

The control unit 110 controls an overall operation of the RFID reader 10 for recognizing a location of an object. In addition, the control unit 110 controls power generation and signal generation operations for recognizing a location of an object. Further, the control unit 110 may control the power generating unit 120 so as to generate power for activating the RFID tags 20 and control the signal generating unit 130 so as to generate a call signal, and the like, for confirming a location of an object. Further, the control unit 110 receives information on the RFID tags 20 or location information on the RFID tag, and the like, that are received through the signal receiving unit 150 to confirm a location of an object through the location information processing unit 170. The control unit 110 may previously acquire the location information of the RFID tags 20 newly entering a space, in which the RFID reader 10 is located, through a separate sensor (not illustrated). In this case, the control unit 110 may immediately can the location information without performing a separate location information acquisition procedure when the location information of the RFID tags 20 is needed.

The power generating unit 120 generates power for activating the RFID tags 20. Further, the power generating unit 120 outputs the generated power to the signal/power transmitting unit 140.

The signal generating unit 130 may generate a call signal, and the like, including tag identifier information corresponding to an object for identifying an object of which the location needs to be recognized In addition, the signal generating unit 130 transmits the generated call signal 130 to the signal/power transmitting unit 140.

The signal/power transmitting unit 140 processes a signal for wirelessly transmit the power signal, the call signal, and the like. Further, the signal/power transmitting unit 140 transmits the signal-processed power signal and call signal to the magnetic resonance unit 150.

The magnetic resonance unit 150 may be configured of a magnetic resonator having the same resonance frequency as the RFID tags 20, for example, a coil, and the like. In addition, the magnetic resonance unit 150 may supply the power signal, the call signal, and the like, that are received from the signal/power transmitting unit 140 to the RFID tags 20. In addition, the magnetic resonance unit 150 may receive the signal from the RFID tags 20. Further, the magnetic resonance unit 150 outputs the received signal to the signal receiving unit 160.

The signal receiving unit 160 performs signal processing on the received signal. Further, the signal receiving unit 160 may acquire the tag identifier information or the location information (coordinate information) on the tags called from the signal-processed received signal. As an example, the location information may be received the RFID tags 20 that are attached at the fixed location. Further, the signal receiving unit outputs the tag identifier information and the location information to the location information processing unit 170 through the control unit 110.

The location information processing unit 170 can detect a location of an object to which the RFID tags 20 are attached based on the location information and the tag identifier information. In addition, the location information processing unit 170 may output a display unit (not illustrated) separately including the information on the location of the detected object or the outside of the RFID reader 10.

The location information processing unit 170 may include a memory 171. The information on the location of the object processed by the location information processing unit 170 may be stored in the memory 171.

The RFID tag 20 may include a magnetic resonance unit 210, a signal/power receiving unit 220, a micro chip 230, and a signal transmitting unit 240. In this configuration, for convenience of explanation, the single RFID tag 20 will be described and the RFID tag 20 may include both of the mobile RFID tags attached to the object and at least one RFID tag attached at the fixed location.

The magnetic resonance unit 210 may be configured of a coil, and the like, having the same resonance frequency as the magnetic resonance unit 150 of the RIFD reader 10. In addition, the magnetic resonance unit 210 may receive the power signal or the call signal.

The signal/power receiving unit 220 may rectify the received power signal to generate power for driving the RFID tag. In addition, the signal/power receiving unit 220 outputs the call signal to the micro chip 230.

The micro chip 230 is driven by receiving power generated through the signal/power receiving unit 220. Further, the micro chip 230 performs the signal processing on the call signal. In addition, the micro chip 230 includes a memory 231 that stores the tag identifier information or the location information.

Here, the RFID tags 20 may be the mobile RFID tags that are attached to the object to identify the location of the object. In this case, when the micro chip 230 receives the call signal from the RFID reader 10, the micro chip outputs the tag identifiers of the RFID tags 20 stored in the memory 231 to the signal transmitting unit 240. In addition, when the tag identifier information is included in the call signal, the micro chip 230 outputs the tag identifiers, the tag confirmation information, and the like, to the signal transmitting unit 240 according to whether the tag identifier information coincides with the tag identifier information stored in the memory 231.

In addition, the RFID tags 20 may be the fixed RFID tags that have the fixed location to provide the location information. In this case, when the micro chip 230 is driven by receiving the power generated through the signal/power receiving unit 220, the micro chip 230 outputs the location information stored in the memory 231 to the signal transmitting unit 240.

The signal transmitting unit 240 performs the signal processing on the received tag identifier or location information so as to be transmitted through the magnetic resonance unit 210. Further, the signal transmitting unit 240 outputs the signal-processed tag information or location information to the magnetic resonance unit 210.

The magnetic resonance unit 210 may transmit the signal-processed tag information or location information to the RFID reader 10.

Here, as described above, the RFID tags 20 may be the mobile RFID tags attached to the object and the fixed RFID tags attached at the fixed location.

The system for recognizing a location of an object in accordance with the embodiment of the present invention applies the RFID technology to the object location recognition and uses the magnetic resonance units 150 and 210 having the same resonance frequency for the RFID reader and the RFID tag 20, respectively. Therefore, the system for recognizing a location of an object may provide the power necessary for object location recognition to the RFID tags 20 from the RFID reader 10.

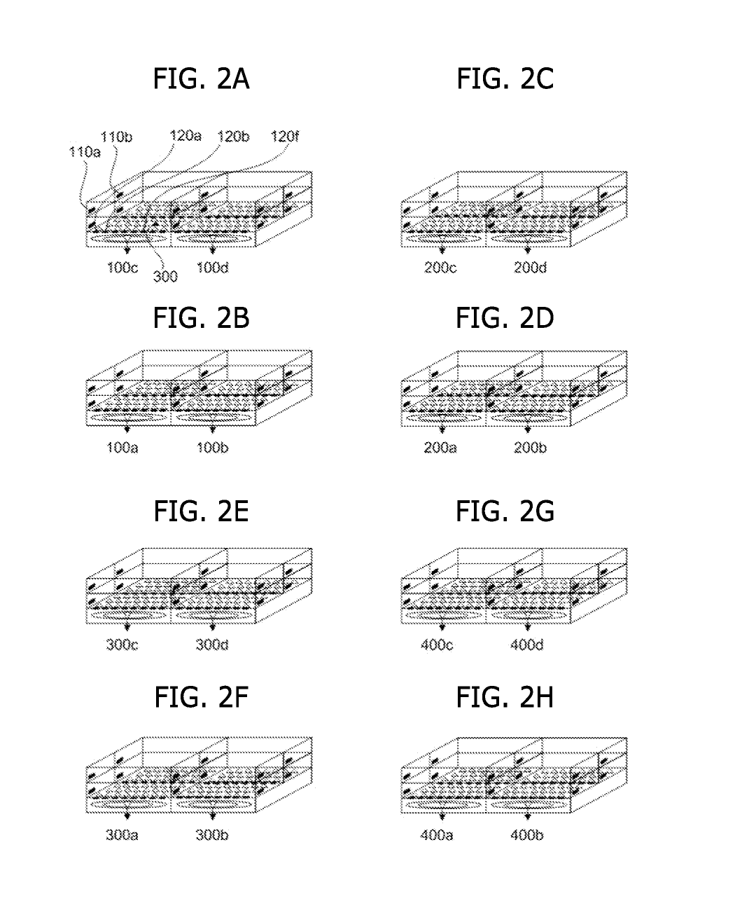

FIGS. 2A to 2H are diagrams illustrating a system for recognizing a location of an object by partitioning a space in accordance with an embodiment of the present invention.

FIGS. 2A to 2H illustrate examples in which the system for recognizing a location of an object uses a plurality of RFID readers 100a to 100d, 200a to 200d, 300a to 300d, and 400a to 400d to partition a space in which the object may be located.

The RFID readers 100a to 100d are used to recognize the location of the object in a first space of FIGS. 2A and 2B. The RFID readers 200a to 100d are used to recognize the location of the object in a second space of FIGS. 2C and 2D. The RFID readers 300a to 100d are used to recognize the location of the object in a third space of FIGS. 2E and 2F. The RFID readers 400a to 400d are used to recognize the location of the object in a fourth space of FIGS. 2G and 2H. Here, the first space to fourth space of FIGS. 2A to 2H, or spaces partitioned for each RFID reader within the first space to fourth space of FIGS. 2A to 2H are previously partitioned space areas for each RFID readers 100a to 100d, 200a to 200d, 300a to 300d, and 400a to 400d.

The plurality of RFID tags communicating with the plurality of RFID readers 100a to 100d, 200a to 200d, 300a to 300d, and 400a to 400d are shown in a black square in the first space to fourth space of FIGS. 2A to 2H.

Further, the RFID readers 100a to 100d, 200a to 200d, 300a to 300d, and 400a to 400d supply power to the mobile RFID tags that are located in each space to search the mobile RFID tags 300 that are attached to the object for location recognition. In addition, when the RFID readers 100a to 100d, 200a to 200d, 300a to 300d, and 400a to 400d communicate with the mobile RFID tags 300 attached to the object, the RFID readers 100a to 100d, 200a to 200d, 300a to 300d, and 400a to 400d supply power to the fixed RFID tags and receive the location information to search the location of the mobile RFID tags 300.

For example, it is assumed that a mobile RFID tags 300 attached to an object are located in the first space of FIGS. 2A and 2B. In this case, an RFID reader 100c can confirm that the RFID tag 300 is located on the space in which the RFID reader 100c is located through the communication with the RFID tag 300. Further, the RFID reader 100c may receive upper location information from the fixed RFID tag 110a located around the mobile RFID tag 300 and lower location information from a fixed RFID tag 120f.

Therefore, the RFID reader 100c may identify the location of the mobile RFID tag 300 through the RFID tags 110a, 110b, . . . , 120a, 120b, . . . , 120f that provide the upper location information and the lower location information.

In this case, the plurality of RFID readers 100a to 100d, 200a to 200d, 300a to 300d, and 400a to 400d may supply power to the RFID tags having the resonance frequency in the magnetic resonance type and receive the tag identifier information or the location information from each RFID tag or the upper and lower location information based on the mobile RFID tag 300.

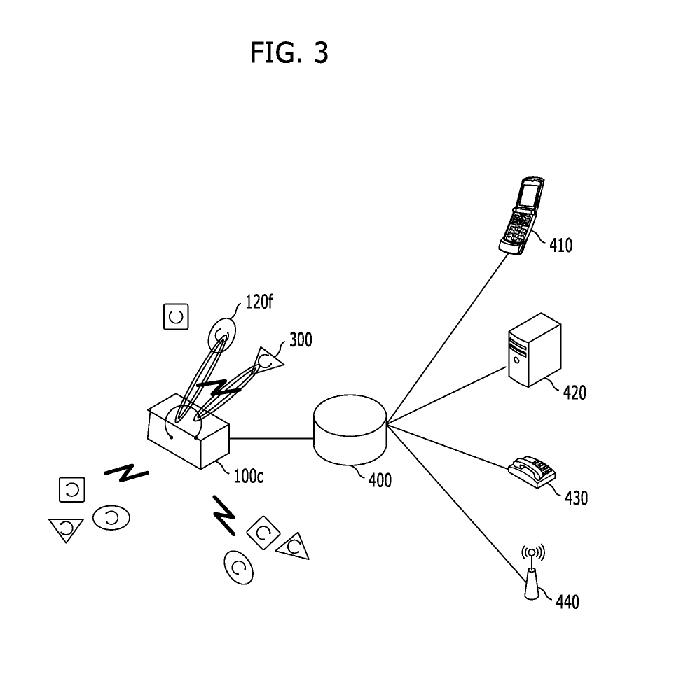

FIG. 3 is a diagram illustrating a use of the system for recognizing a location of an object in accordance with an embodiment of the present invention.

Referring to FIG. 3, the system for recognizing a location of an object may include the plurality of RFID tags 120f and 300, the RFID reader 100c, a location recognition server 400, location recognition information application devices 410, 420, 430, and 440.

The RFID reader 100c is the RFID reader 100 that is located in the first space of FIGS. 2A and 2B. In this case, the RFID reader 100c may be connected with the location recognition server 400 for recognizing the location of the object.

In addition, the RFID reader 100c may recognize the location of the object to which the mobile RFID tag 300 is attached through the communication with the mobile RFID tag 300 and the fixed RFID tag 120f. Further, the RFID reader 100c provides the recognized location information of the object to the location recognition server 400.

The location recognition server 400 may request the object location recognition from the plurality of RFID readers 100a to 100d, 200a to 200d, 300a to 300d, and 400a to 400d and receive the recognized location information of the object. Further, the location recognition server 400 may drive application programs using the location information of the object.

Further, the location recognition server 400 may request the location information of the object or be operated by cooperating with the location recognition information application devices 410, 420, 430, and 440 for providing the requested location information of the object. Further, the location recognition server 400 may also be operated by a control of the location recognition information application devices 410, 420, 430, and 440.

The location recognition information application devices 410, 420, 430, and 440 may receive the location information of the object. The location recognition information application devices 410, 420, 430, and 440 may include, for example, a mobile phone 410, a personal computer (PC), a telephone 430, a base station/access point 440, and the like. Here, the location recognition information application devices 410, 420, 430, and 440 may also control the location recognition server 400 through an interface with a user of the system for recognizing a location of an object.

For example, the location recognition system in accordance with the embodiment of the present invention may be used for application services, and the like, such as allowing a person to search the location of the object located around a person.

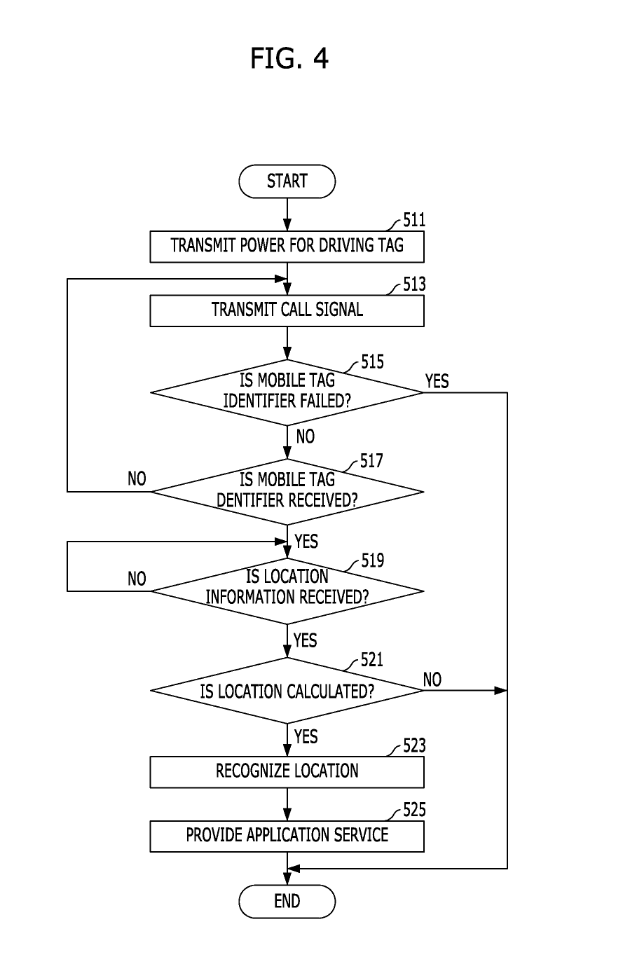

FIG. 4 is a flow chart illustrating an operation of the RFID reader in accordance with an embodiment of the present invention.

Referring to FIG. 4, in S511, the RFID reader 10 transmits power for driving the mobile RFID tag (hereinafter, referred to as a ‘mobile tag’) and the fixed RFID tag (hereinafter, referred to as a ‘fixed tag’). Here, the power is transmitted to the mobile tags and the fixed tags, respectively, from the RFID reader 10 in the magnetic resonance type using the resonance frequency.

Further, in S513, the RFID reader 10 transmits the call signal requesting the transmission of the tag identifiers so as to confirm whether the identifiers (hereinafter, referred to as a ‘tag identifier’) of the mobile tags attached to the object of which the location needs to be recognized are present. Here, the call signal includes the tag identifier information of the object of which the location needs to be recognized to activate only the mobile tag of the object of which the location needs to be recognized through the call signal.

Thereafter, in S515, the RFID reader 10 determines whether the reception of the tag identifier information fails. The reception failure of S515 is a process of determining whether the tags are not present in the corresponding area of the RFID reader 10, whether time for receiving the tag identifiers sufficiently lapses, and the like.

As the determination result in S515, the RFID reader ends when the reception of the tag identifier information fails. However, as the determination result in S515, the RFID reader 10 proceeds to S517 if it is determined that the reception of the tag identifier information does not fail.

Further, in S517, the RFID reader 10 confirms whether the tag identifier information is received. As the confirmation result in S517, the RFID reader 10 proceeds to S513 when the tag identifier information is not received. However, as the confirmation result in S517, the RFID reader 10 proceeds to S519 when the tag identifier information is received.

Next, in S519, the RFID reader 10 determines whether the location information of the mobile tags from the fixed tags is received. Here, the RFID reader 10 may also transmit the power for driving the fixed tags. As the determination result in S519, the RFID reader 10 proceeds to S519 when the location information is not received to wait for the reception of the location information. However, as the determination result in S519, the RFID reader 10 proceeds to S521 when the location information is received.

Next, in S521, the RFID reader 10 confirms that the location can be calculated using the received location information. Next, as the confirmation result in S521, the RFID reader 10 ends when the location cannot be calculated using the received location information. However, as the confirmation result in S521, the RFID reader 10 proceeds to S523 when the location can be calculated using the received location information.

Further, in S523, the RFID reader 10 recognizes the location of the mobile tags using the location information.

Next, in S525, the RFID reader 10 may provide the application services through the location recognition of the mobile tags. Here, the RFID reader 100 may provide the location recognition information such as the separate location recognition server 400, and the like, for providing application services or directly provide the application services through the RFID reader 10.

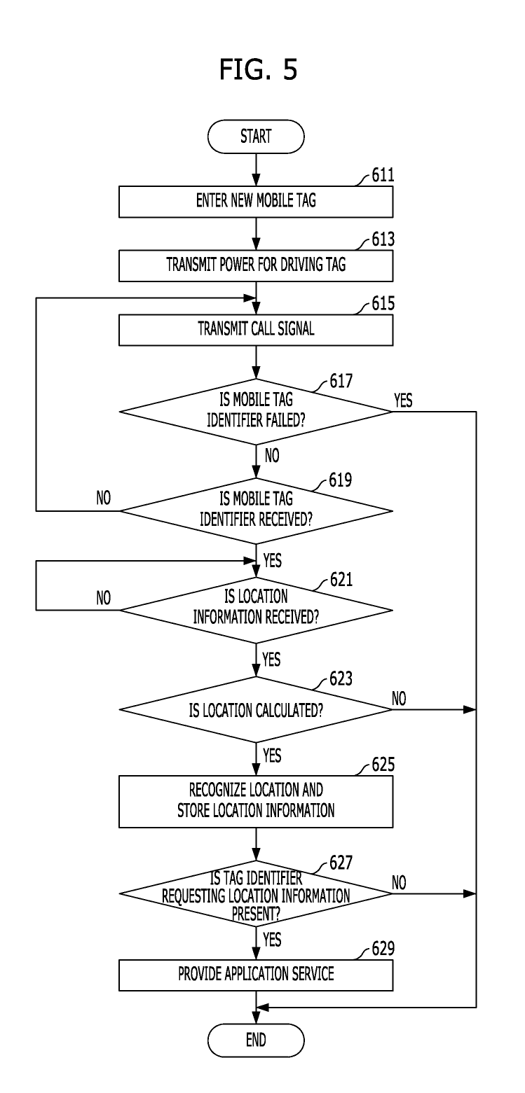

FIG. 5 is a flow chart illustrating an operation of the RFID reader in accordance with another embodiment of the present invention.

Referring to FIG. 5, in S611, the RFID reader 10 confirms that a new mobile tag enters its own area. To this end, the RFID reader 10 may include a sensor (not illustrated), and the like, for sensing the entering of the mobile tags into the area of the RFID reader 10.

Next, in S613, the RFID reader 10 transmits power for driving the mobile tags and the fixed tags. Here, the power is transmitted to the mobile tags and the fixed tags, respectively, from the RFID reader 10 in the magnetic resonance type using the resonance frequency.

Next, in S615, the RFID reader 10 transmits the call signal requesting the transmission of the tag identifiers of the newly entered mobile tags.

Next, in S617, the RFID reader 10 determines that the reception of the tag identifier information fails. The reception failure in S617 is a process of determining whether time for receiving the tag identifiers sufficiently lapses in the RFID reader 10, and the like.

In the determination result in S617, the RFID reader ends when the reception of the tag identifier information fails. However, as the determination result in S617, the RFID reader 10 proceeds to S619 when the reception of the tag identifier information does not fail.

Further, in S517, the RFID reader 10 confirms whether the tag identifier information is received. In the confirmation result in S619, the RFID reader 10 proceeds to S615 when the tag identifier information is not received. However, as the confirmation result in S619, the RFID reader 10 proceeds to S621 when the tag identifier information is received.

Next, in S621, the RFID reader 10 determines whether the location information of the mobile tags from the fixed tags is received. Here, the RFID reader 10 may also transmit the power for driving the fixed tags. As the determination result in S621, the RFID reader 10 proceeds to S621 when the location information is not received to wait for the reception of the location information. However, as the confirmation result in S621, the RFID reader 10 proceeds to S623 when the location information is received.

Next, in S623, the RFID reader 10 confirms whether the location can be calculated using the received location information. Next, as the confirmation result in S623, the RFID reader 10 ends when the location cannot be calculated using the received location information. However, as the confirmation result in S623, the RFID reader 10 proceeds to S625 when the location can be calculated using the received location information.

Further, in S625, the RFID reader 10 recognizes the location of the mobile tags using the location information and stores the location recognized information in the memory 171 of the RFID reader 10.

Next, in S627, the RFID reader 10 determines whether the tag identifiers (objects) of the mobile tags of which the location information is requested are present in the memory 171, and the like, when the location information is requested according to the driving of the application services. As the determination result in S627, the RFID reader 10 ends when the requested tag identifier information is not present. However, as the confirmation result in S627, the RFID reader 10 proceeds to S629.

Next, in S629, the RFID reader 10 may provide the application services through the location information of the mobile tags. Meanwhile, in S627, the RFID reader 100 receives a request of the location information of the mobile tags from the external location recognition server 400, and the like. In this case, the RFID reader 10 may also provide the location recognition information to the separate location server 400 so as to provide application services.

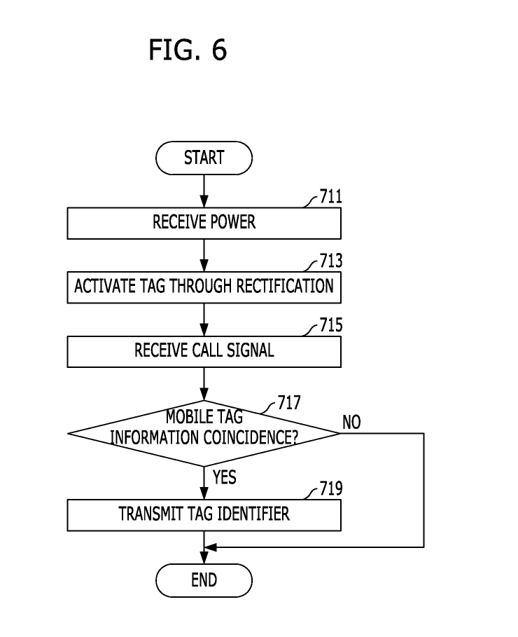

FIG. 6 is a flow chart illustrating an operation of the mobile RFID tags in accordance with an embodiment of the present invention.

Referring to FIG. 6, in S711, the mobile tags receive power through the magnetic resonance unit 210 having the same frequency as the RFID reader 10.

Further, in S713, the mobile tags activate the mobile tags by rectifying the received power and supplying the rectified power.

Next, in S715, the mobile tags receive the call signal from the RFID reader 10. Here, the call signal includes the tag identifiers for searching a location of an object.

Next, in S717, the mobile tags confirms whether the tag identifiers included in the call signal coincides with the tag identifier information stored in a memory 231, and the like, that is located in the mobile tags. As the confirmation result in the S717, the mobile tags end when the tag identifiers coincide with each other. As the confirmation result in the S717, the mobile tags proceed to S719 when the tag identifiers coincide with each other.

Further, S719, the mobile tags transmit the tag identifier, the tag confirmation information, and the like, to the RFID reader and the operation thereof ends.

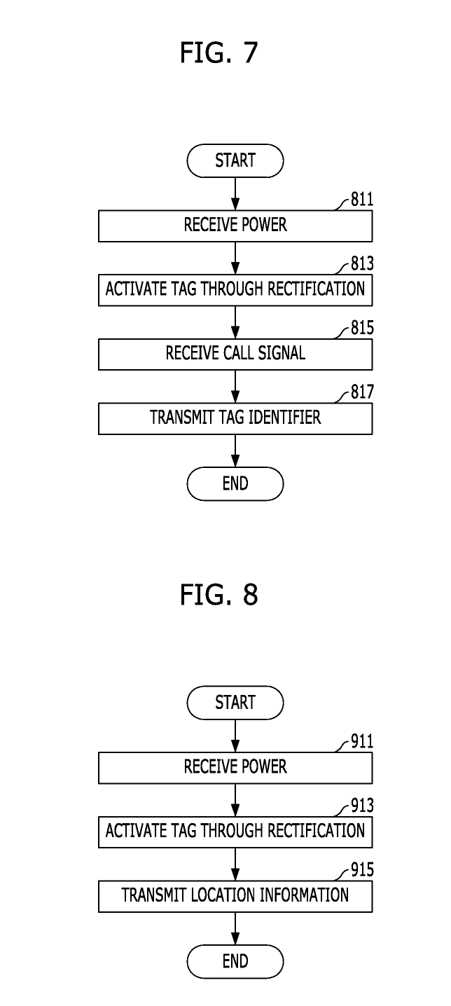

FIG. 7 is a flow chart illustrating an operation of the mobile RFID tags in accordance with another embodiment of the present invention.

Referring to FIG. 7, in S811, the mobile tags receive power through the magnetic resonance unit 210 having the same frequency as the RFID reader 10.

Further, in S813, the mobile tags activate the mobile tags by rectifying the received power and supplying the rectified power.

Next, in S815, the mobile tags receive the call signal from the RFID reader 10. The call signal is a signal requesting the transmission of the tag identifiers.

Next, in S817, the mobile tags transmit the tag identifiers to the RFID reader and the operation ends.

FIG. 8 is a flow chart illustrating an operation of the fixed RFID tags in accordance with another embodiment of the present invention.

Referring to FIG. 8, in S911, the fixed tags receive power through the magnetic resonance unit 210 having the same frequency as the RFID reader 10.

Further, in S913, the fixed tags activate the fixed tags by rectifying the received power and supplying the rectified power.

Next, in S915, the fixed tags may transmit the location information stored therein. Here, the fixed tags are located at the fixed location within a distance in which they can communicate with the RFID reader 10. Therefore, the fixed tags have the location information.

The system for recognizing a location of an object in accordance with the embodiment of the present invention, the magnetic resonance type wireless power transmission supplies power using the resonant frequency of magnetic field to secure the maximum transmission efficiency 80% higher than a magnetic induction type (only a part of electromagnetic field of the transmitting side passes through a cross sectional area of the coil and thus, the efficiency of the generated power is very low), an electromagnetic inverse scattering type (using external batteries for deriving chips in the tags), an electrical coupling type (using a wide plate by electrical coupling using capacitance), and the like. Therefore, the system for recognizing a location of an object in accordance with the embodiment of the present invention can greatly improve the location recognition distance of the object and the performance of the supply of power. In addition, the system for recognizing a location of an object in accordance with the embodiment of the present invention can perform the broadband communication between the RFID reader and the RFID tags within a range between 1 cm and 100 cm.

In accordance with the embodiments of the present invention, it is possible to sufficiently supply power required for the object location recognition by allowing the apparatus for recognizing a location of an object in the location recognition system to supply power to tags using the magnetic resonant radio power transmission. In addition, in accordance with the embodiment of the present invention, it is possible to improve the power transmission performance for object location recognition by allowing the location recognition apparatus to transmit radio power in the magnetic resonance type.

Although the exemplary embodiments of the present invention have been disclosed for illustrative purposes, various modifications, additions and substitutions are possible, without departing from the scope and spirit of the invention as disclosed in the accompanying claims. Accordingly, the scope of the present invention is not construed as being limited to the described embodiments but is defined by the appended claims as well as equivalents thereto.

What is claimed is:

1. An apparatus for recognizing a location of an object in a location recognition system, comprising:
a power generating unit configured to generate power;
a signal generating unit configured to generate a call signal including an identifier of a mobile tag so as to search a location of the mobile tag attached to an object;
a signal/power transmitting unit configured to output the power and the call signal;
a magnetic resonance unit configured to transmit the power in a magnetic resonance type and transmit the call signal;
a control unit configured to perform a control to transmit the power and the call signal to neighboring tags;
a signal receiving unit configured to receive identifier information of the mobile tag and location information of the mobile tag corresponding to the call signal through the magnetic resonance unit; and
a location information processing unit configured to recognize the location of the object using the location information.

2. The apparatus of claim 1, wherein the location recognition apparatus is an RFID reader communicating with the mobile tag.

3. The apparatus of claim 1, wherein the signal receiving unit receives the location information of the mobile tag from fixed tags located around the mobile tag.

4. The apparatus of claim 1, wherein the location information is top/bottom location information based on the location of the mobile tag.

5. The apparatus of claim 4, wherein the magnetic resonance unit has the same resonance frequency as the mobile tag.

6. The apparatus of claim 1, wherein the RFID reader recognizes the location of the mobile tag within a previously partitioned space.

7. The apparatus of claim 6, wherein the control unit acquires the location information of the mobile tag when a new mobile tag enters the space.

8. The apparatus of claim 7, wherein the location information processing unit includes a memory that stores the location information acquired from the entered mobile tag.

9. The apparatus of claim 1, wherein the location information processing unit provides application services using the acquired location information to a location recognition server.

10. A method for recognition a location of an object in a location recognition system, comprising:
activating tags located around radio frequency identification (RFID) tags by transmitting power to the RFID tags in a magnetic resonance type;
transmitting a call signal for identifying a mobile tag attached to an object;
receiving a tag identifier of the mobile tag corresponding to the call signal;
receiving location information from fixed tags around the mobile tag; and
recognizing the location of the mobile tag using the location information.

11. The method of claim 10, wherein the activating of the tags includes transmitting power using the same resonance frequency as the resonance frequency of the tags.

12. The method of claim 10, wherein the location information is top/bottom location information of the mobile tag acquired from the fixed tags around the location recognition apparatus.

13. The method of claim 10, wherein the call signal includes tag identifier information of the mobile tag.

14. The method of claim 13, wherein in the receiving of the tag identifier, the tag identifier is received from the mobile tag storing the tag identifier included in the call signal.

15. The method of claim 10, wherein the activating of the tags includes supplying power for communicating with the mobile tag and the fixed tags using an RFID mechanism.

16. A method for recognizing a location of an object in a location recognition system, comprising:
sensing a reception of a mobile tag attached to an object within a space of the location recognition system;
activating tags located around radio frequency identification (RFID) tags by transmitting power to the RFID tags in a magnetic resonance type;
transmitting a call signal for receiving a tag identifier of the mobile tag;
receiving the tag identifier of the mobile tag corresponding to the call signal;
receiving location information from fixed tags around the mobile tag;
recognizing a location of the mobile tag using the location information;
storing location information of the mobile tag; and
providing the location information by searching the location information of the requested tag identifier, when the location information of an object required for location recognition is requested.

17. The method of claim 16, wherein the activating of the tags includes transmitting power using the same resonance frequency as the resonance frequency of the tags.

18. The method of claim 16, wherein the location information is top/bottom location information of the mobile tag acquired from the fixed tags around the location recognition apparatus.

19. The method of claim 16, wherein the activating of the tags includes supplying power for communicating with the mobile tag and the fixed tags using an RFID mechanism.
